(19) United States
(12) Patent Application Publication
(10) Pub. No.: US 2020/0076594 A1
(43) Pub. Date: Mar. 5, 2020

(54) KEY UPDATE FOR MASKED KEYS

(71) Applicant: The Athena Group, Inc., Gainesville, FL (US)

(72) Inventor: Stuart AUDLEY, Gainesville, FL (US)

(21) Appl. No.: 16/089,696

(22) PCT Filed: Mar. 30, 2017
(86) PCT No.: PCT/US2017/025130

§ 371 Date: Sep. 28, 2018

Related U.S. Application Data
(60) Provisional application No. 62/315,415, filed on Mar. 30, 2016.

(51) Int. Cl. H04L 9/08; H04L 9/06; H04L 9/32

(52) U.S. Cl. CPC H04L 9/0891; H04L 9/3242; H04L 9/0618; H04L 9/085

(57) ABSTRACT

Embodiments of the present invention provide methods to perform key updates on key shares of a masked key, which allows updating the masked key without unmasking the masked key (e.g., producing the effective key). By using key shares of a masked key and performing the key update on one or more of the key shares without unmasking the effective key, the cumulative leakage of individual effective keys across multiple cryptographic operations is reduced, and preferably minimized.

### CROSS-REFERENCE TO RELATED APPLICATION(S)

The present application claims the benefit of U.S. Provisional Application Ser. No. 62/315,415, filed on Mar. 30, 2016; which is hereby incorporated by reference herein in its entirety, including any figures, tables, or drawings.

### FIELD OF INVENTION

Embodiments of this invention relate generally to integrated circuits (ICs) and, more particularly, to a system for processing and/or storing sensitive data that may, should, or must be kept secure.

### BACKGROUND OF INVENTION

Integrated circuits (ICs) take a multitude forms, including digital memory chips, microprocessors, central processing units (CPUs), application specific integrated circuits (ASICs), application specific standard products (ASSPs), field-programmable gate arrays (FPGAs), hardware security modules (HSMs), and more. For many systems containing ICs, it is important to protect the electronically stored and/or processed data, including, but not limited to, computer access control, military weapons systems, medical information, vehicle control, secure communications, and payment transaction processing. The security for the data these systems process often relies on cryptographic operations based on secret keys stored in memory or other circuitry, which arc then used to cryptographically secure sensitive data from unauthorized access.

Information leaked from circuits performing cryptographic operations (cryptographic circuits) can be analyzed by attackers to determine the secret key(s) being used to secure information. In particular, information leaked from cryptographic circuits via side channels such as electromagnetic emanations or power consumption variations during these cryptographic processes can be analyzed to determine the secret keys or sensitive data being processed.

Utilizing masking keys (secret keys), and logic, reduce the amount of leakage per cryptographic operation and utilizing key updates limit the amount of cumulative leakage of individual secret keys across multiple cryptographic operations. By utilizing masked keys and key updates, the secret information leaked during cryptographic operation can be significantly reduced. Current methods that utilize both masked keys and key updates together perform key updates on an unmasked key and then mask the updated key before using the masked key in the cryptographic operation. Performing key updates on the unmasked key, and then masking the updated unmasked key, leaks key information while the unmasked key is in use (e.g., stored, operated on, and/or retrieved).

The masking and unmasking operations demonstrably leak key information. This key information leakage could be used by template attacks to reveal all or part of the secret key. Additionally, the key update operation on unmasked keys can potentially leak a significant amount of key information. As an example, using SHA hash without leakage reduction countermeasures as the key update function for an unmasked key could potentially reveal the key being updated with a limited number of power or electromagnetic operation traces. Even with a key update after every cryptographic operation, a sufficient number of key update operation traces could be acquired for a successful attack by restarting the entire set of operations many times.

In order to minimize key leakage from the key update operation, multiple countermeasures can be used with varying levels of complexity and effectiveness. Examples are described is U.S. Pat. No. 6,327,661—Using unpredictable information to minimize leakage from smartcards and other cryptosystems; U.S. Pat. No. 6,539,092—Leak-resistant cryptographic indexed key update; and U.S. Pat. No. 7,787,620—Prevention of side channel attacks against block cipher implementations and other cryptographic systems.

Methods have been developed to quantify the amount of side channel leakage occurring during cryptographic operations. One such method is test vector leakage assessment (TVLA), which statistically compares power or electromagnetic signatures of a fixed key and random keys [J. Cooper, E. Demulder, G. Goodwill, J. Jaffe, G. Kenworthy, and P. Rohatgi. Test Vector Leakage Assessment (TVLA) Methodology in Practice, International Cryptographic Module Conference, 2013]. Using this testing methods, it can be determined what techniques best minimize side channel key leakage. TVLA experimentally has shown that using a masked key provides a reduction in side channel leakage compared to directly using the effective unmasked key. Key shares of a masked key form the effective key by using a masking operation. The effective key corresponds to the key defined by the specification of the cryptographic algorithm being used. Masked shares can be produced by performing the masking operation on the effective key and unpredictable data.

An example of Boolean masking using the XOR operator for two key shares is
keyshare 1=effective_key XOR unpredictable_dat
keyshare2=unpredictable_data.

An example of Boolean masking using the XOR operator for three key shares is
keyshare 1=effective_key XOR unpredictable_data1 XOR unpredictable_data2
keyshare2=unpredictable_data1
keyshare3=unpredictable_data2

An example of arithmetic(additive) masking using the +/− operators for two key shares is
keyshare1=effective_key—unpredictable_dat
keyshare2=unpredictable_data.

An example of arithmetic (additive) masking using the +/− operators for three key shares is
keyshare1=effective_key—unpredictable_data1—unpredictable_data2
key share2=unpredictable_data1
keyshare3=unpredictable_data2

An example of multiplicative masking using the * operators for three key shares is
keyshare1=effective_key * unpredictable_data1⁻¹* unpredictable_data2⁻¹
keyshare2=unpredictable_data1
keyshare3=unpredictable_data2

Key shares of a masked key can be unmasked to produce the effective key by using an unmasking operation.

An example of Boolean unmasking using the XOR operator for two key shares is effective_key=keyshare1 XOR keyshare2

An example of Boolean masking using the XOR operator for three key shares is effective_key=keyshare1 XOR keyshare2 XOR keyshare3

An example of arithmetic (additive) masking using the +/− operators for two key shares is effective_key=keyshare1+keyshare2

An example of arithmetic (additive) masking using the +/− operators for three key shares is effective_key=keyshare1+keyshare2+keyshare3

An example of multiplicative masking using the * operators for three key shares is effective_key=keyshare1 * keyshare2 * keyshare3

Masking and unmasking operations are not limited to the previous examples as any logical function that has two or more inputs and an inverse can be used as a basis for masking and unmasking operations. Also rather than masking an effective key, generating the key share values directly prevents the effective key value from ever being stored or transmitted.

In order to minimize the amount of side-channel leakage of an effective key being used in a keyed cryptographic operation, the key lifetime of the effective key (e.g., the number of keyed cryptographic operations performed by the effective key) should be limited. This key lifetime can be as little as one keyed cryptographic operation. In order to perform more keyed cryptographic operations than the key lifetime of the effective key, a key update can be performed when the key lifetime end of the effective key has been reached, where the key update produces an updated effective key.

Using both masked key shares and key updates can significantly reduce the amount of usable secret information leaked during multiple cryptographic operations.

A common method to utilize both masked keys and key updates in the same system is to perform key updates on an unmasked effective key and then split the updated key into shares shares of the masked key before using the masked key in the cryptographic operation. Key information will leak while the unmasked key is being updated, stored, and split.

Another method utilizes both masked keys and key updates in the same system, but is limited to reordering and randomization, which do not change the effective value of the key (i.e., the effective key) being updated (see U.S. Pat. No. 7,787,620). If a key update does not change the effective value of the key then it does not limit the amount of cumulative leakage of effective key across multiple cryptographic operations.

### BRIEF SUMMARY

Embodiments of the present invention provide methods to perform key updates on key shares of a masked key, which allows updating the masked key without unmasking the masked key (e.g., producing the effective key). By using key shares of a masked key and performing the key update on one or more of the key shares without unmasking the effective key, the cumulative leakage of individual effective keys across multiple cryptographic operations is reduced, and preferably minimized.

### BRIEF DESCRIPTION OF DRAWINGS

FIG. 1 is a block diagram of an embodiment of a keyed cryptographic module with a two-share masked key.

FIG. 2 is a block diagram of a circuit, incorporating the keyed cryptographic module of FIG. 1, where a key update is performed on the unmasked key, and then the updated key is masked to create an updated two-share masked key, which forms the effective key for a keyed cryptographic operation.

FIG. 3 is a block diagram of a circuit, incorporating the keyed cryptographic module of FIG. 1, where a corresponding key update function is performed on each key share of a two-share masked key to create an updated two-share masked key, which forms the effective key for a keyed cryptographic operation.

FIG. 4 is a block diagram of a circuit, incorporating the keyed cryptographic module of FIG. 1, where a key update function is performed on one of the key shares of a two-share masked key, which forms the effective key for a keyed cryptographic operation.

FIG. 5 is a block diagram of a circuit, incorporating the keyed cryptographic module of FIG. 1, where a key update function with two-share masked input and output is performed on the key share of a two-share masked key, which forms the effective key for a keyed cryptographic operation.

FIG. 6 is a block diagram of a circuit, incorporating the keyed cryptographic module of FIG. 1, where a key update function with two-share masked input and output is performed on two out of three key shares of a three-share masked key and combining the second key share and the third key share to form a combined key share, such that the first key share and the combined key share form a two-share masked key, which forms the effective key for a keyed cryptographic operation.

FIG. 7 is a block diagram of a circuit, incorporating a keyed cryptographic module with a three-share masked key, analogous to FIG. 1, where a key update function with two-share masked input and output is performed on two out of the three key shares of a three-share masked key to form a further three-share masked key, which forms the effective kcy for a keyed cryptographic operation.

FIG. 8 is a block diagram of a circuit, incorporating the keyed cryptographic module of FIG. 1, where a key update function with two-share masked input and output is performed on each of two pairs of key shares of a four-share masked key, and combining a first half pair of each of the two pairs of key shares to form a first combined key share, and combining a second half pair of each of the two pairs of key shares to form a second combined key share, such that the first combined key share and the second combined key share form a two-share masked key, which forms the effective key for a keyed cryptographic operation.

### DETAILED DISCLOSURE

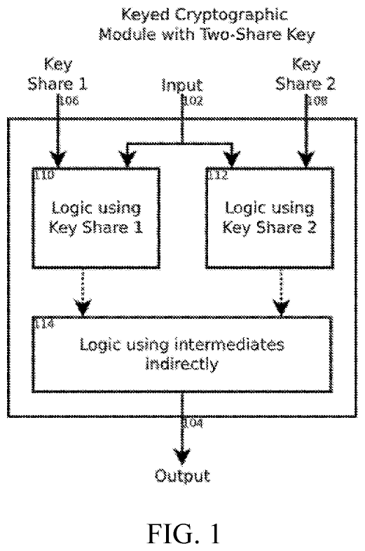

Embodiments of the subject invention relate to cryptographic systems that use key shares of a masked key and logic, which can reduce side channel leakage of the effective key. An example block diagram of a keyed cryptographic module with input (102), output (104) and a two-share masked key (106,108) is shown in FIG. 1. This module can be implemented via hardware, such as logic gates, and/or software, such as instructions. The input (102) to the keyed cryptographic module can consist of a single input such as plaintext to be encrypted or multiple inputs such as plaintext to be encrypted and an initialization vector. Additionally the inputs may be masked shares consisting of multiple input values where when unmasked produce the effective output value. The output (104) to the keyed cryptographic module can consist of a single output such as ciphertext or multiple outputs such as ciphertext, resulting initialization vector, and message authentication code. Additionally the outputs may be masked shares consisting of multiple output values where when unmasked produce the effective output value. This keyed cryptographic module can represent a symmetric key block cipher module, such as AES (Advanced Encryption Standard). If used for encryption then the input (102) is the plaintext and the output (104) is the ciphertext, and if used for decryption then the input (102) is the ciphertext and the output (104) is the plaintext. Additionally, FIG. 1 can represent a keyed message authentication module, such as HMAC (keyed-hash message authentication code), where the input (102) is the input message to be authenticated and the output (104) is the message authentication code. The keyed cryptographic module in FIG. 1 minimizes leakage by performing separate logic operations on each key share to produce corresponding intermediates as shown in 110 and 112 and only combining the intermediates separately (114) to form the output. FIG. 1 serves to show an embodiment of a keyed cryptographic module, which can be utilized in accordance with the subject invention. Further embodiments of a keyed cryptographic module can have a different internal structure, different masked share input and outputs, and/or more than two mask shares (an effective key with more than two key shares).

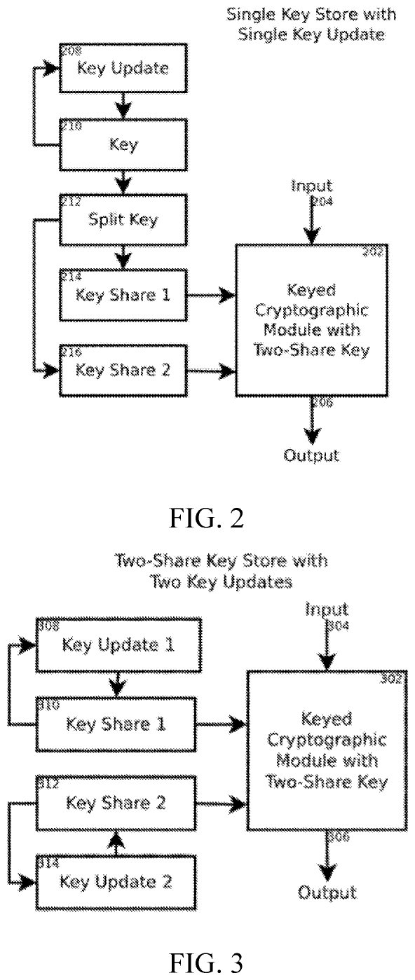

FIG. 2 shows an example system that performs a key update on an unmasked key, which is the effective key, and then masks the effective key to create a two-share masked key, i.e., two key shares that when unmasked via the masking operation produces the effective key. The key shares are then input into a keyed cryptographic module with a two-share key. The unmasked key (210) is directly stored as the effective key, which leaks information when accessed and stored. Additionally, the key update function (208) is performed directly on the effective key (210), which leaks information. By storing the unmasked key directly and performing the key update directly on the effective key, FIG. 2 leaks information that could be used by an attacker to reveal all or part of the secret key and thereby compromise the security of the system.

Although the circuit of FIG. 2 does not perform unmasking, the circuit stores the unmasked key and updates the unmasked key, which can leak key information. Using a pre-masked key share (e.g., as shown in FIG. 3) and performing the key update function on one or more key shares of the effective key, reduces, and preferably eliminates, leaks associated with unmasking (e.g., retrieving, updating, and/or storing the unmasked key). FIG. 3 shows an example system with a two-share key store (310,312) where a corresponding key update function (308,314) is performed on each key share. If, for example, both 308 and 314 are set to be a cryptographic hash function such as SHA (Secure Hash Algorithm) and the masking operation is XOR then the key would be updated keyₐ=SHA(keyₐ) and key_{b}=SHA(key_{b}), where the effective key (i.e., unmasked key), keyₐ XOR key_{b}, is never directly used or stored. This method in FIG. 3 reduces, and preferably eliminates, the need to ever unmask the masked key.

The key update algorithm is not limited to cryptographic hash functions. Rather, any logic function can be used to perform the key update. Depending on the desired properties of the key update and implementation constraints, different key update functions can be used. A one-way cryptographic function, such as s cryptographic hash, provides backtracking resistance, which means information about a current key cannot be used to determine information about previously used keys in the key update process.

A block cipher, such as AES, can be used as the key update function in the circuit of FIG. 3. Using the keyed cryptographic module in FIG. 3 to perform the key update function can help constrain the resources required to implement key updates. When using a block cipher as the key update function, multiple different approaches are available. When data from a received or stored message is available, the block cipher key update can be configured where the block cipher key is the key to be updated, the input is received or stored message, and the output is the updated key. Alternatively, the block cipher key update can be configured where the block cipher key is the received or stored message, the input is the key to be updated and the output is the updated key. If a received or stored message is not available the message can be replaced with constant data.

A function linear to the masking operation can be used as the key update function. Functions that are linear to the masking operation often have less side channel leakage and require minimal additional resources. However, functions linear to the masking operation are more susceptible to backtracking compared to a one-way cryptographic function or a block cipher. An example of a function linear to the masking operation is an affine transform based on the masking operation, such as XOR.

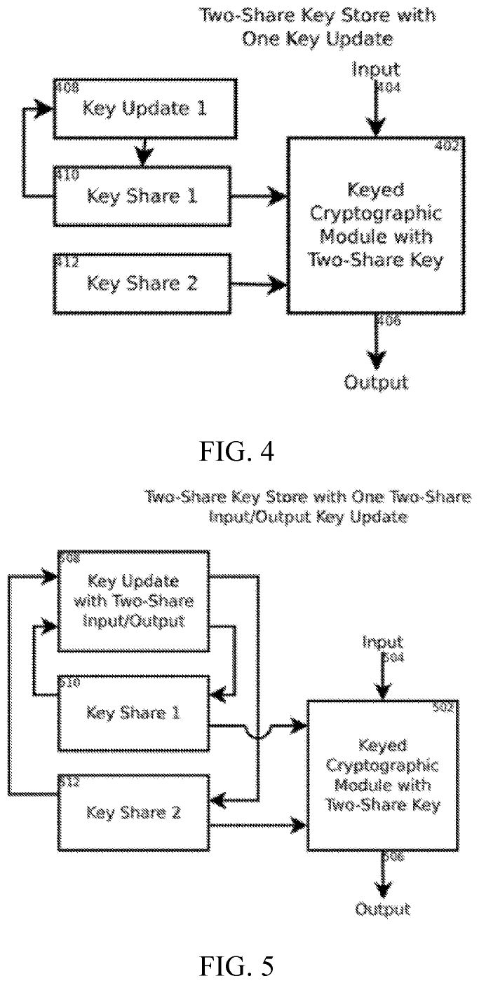

When using a key update function that is leaky, for example in the circuit of FIG. 3, an attacker could obtain key information by analyzing the key update operation for each key share of the masked key. Obtaining key information about each key share can reveal information about the effective key that the key shares represent. One option to reduce the risk of revealing information about all of the key shares during key update is to update at least one of the key shares and not update at least one of the other key shares. FIG. 4 shows an example system with a two-share key store (410,412) to store the two key shares of a two-share masked key, where a key update function (408) is performed only on 410 and not on 412.

Since the key update functions can potentially leak key information, leakage reduction countermeasures can be used in the key update functions. In a specific embodiment, the key update functions utilize one or more key shares of the masked key as inputs and one or more outputs are provide to a corresponding one or more key shares. In a specific embodiment, two or more key shares of the masked key are used as inputs of the key update function and outputs of the key update function are provided to two or more key shares. In a further specific embodiment, the two or more outputs of the key update function are provided to the same two or more key shares that are provided as inputs of the key update function. The increase in key shares and key storage memory provides more secure processing of the key update function. Additionally, key update functions that are linear to the masking operation process each key share individually as a single masked operation, which helps minimize the overall key update leakage.

FIG. 5 shows an embodiment of a system with a two-share key store (510,512) where a two-share input and output key update function (508) is used to update both key shares. This means that the update of each key share in FIG.5 utilizes the other key share.

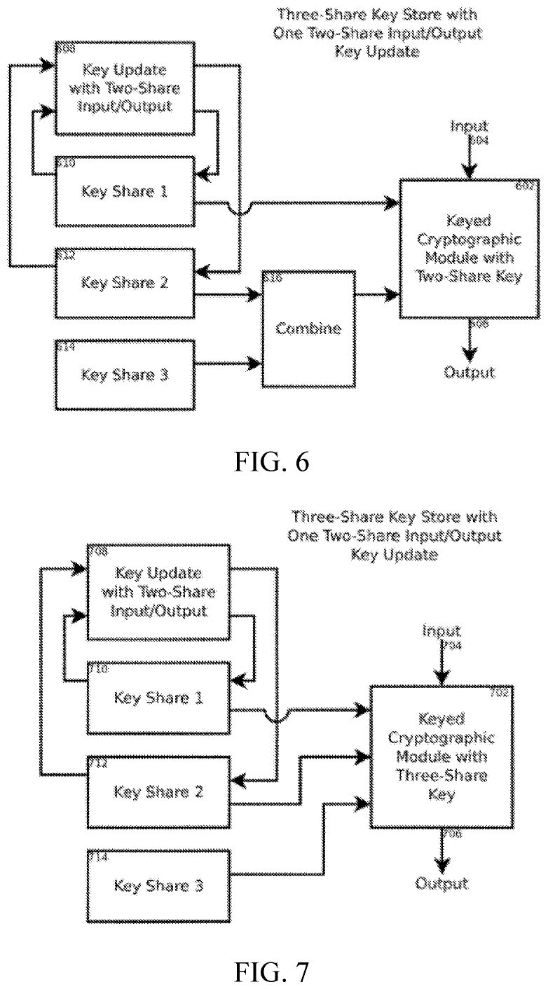

FIG. 6 shows an example system with a three-share key store (610,612,614) where a two-share input and output key update function (608) is used to update 610 and 612 and no key update function is performed on 614. 612 and 614 are combined using the masking operation to provide the second key share for the two-key share cryptographic module. FIG. 7 shows an example system with a three-share key store (710,712,714) where a two-share input and output key update function (708) is used to update 710 and 712 and no key update function is performed on 714. Since 702 is a keyed cryptographic module supporting a three-share key there is no need to combine 712 and 714 as done in FIG. 6

When performing key updates on the individual key shares of the masked key, the key update function can be unique for each key share. For instance, FIG. 3 can use different key update functions for 308 and 314, such as 308 being the SHA hash and 314 being an affine transformation. Performing key updates separately on the individual key shares of the masked key allows such updating to be performed in parallel, which can reduce the computational time required to perform the complete key update, and the different update functions can provide different additive properties to the key update function. For example, the hash update function makes the overall key update function cryptographically one-way, and a key update function that is linear to the masking operation (such as an affine transformation) provides improved leakage resistance to the overall key update function.

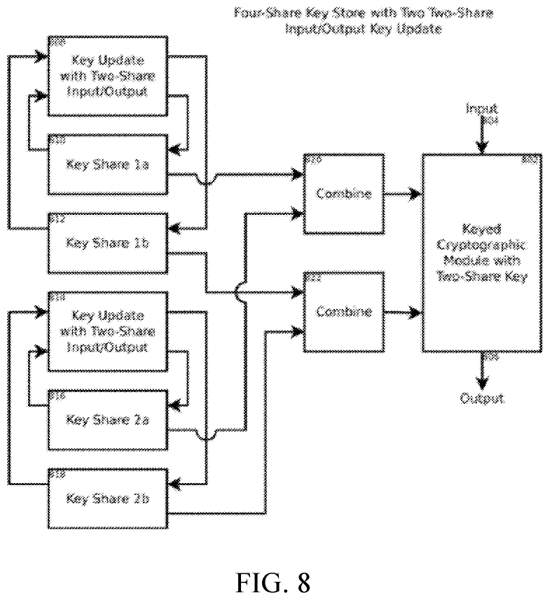

Using different key update functions can be combined with using a key update function with masked input and output. FIG. 8 shows an example system with a four-share key store (810,812,816,818) where the two-share input and output key update function (808) updates 810 and 812 and 814 updates 816 and 818. Since 802 is a two-share cryptographic module each pair halves (810 with 816 and 812 with 818) are combined using the masking operation to provide the two-share key.

Various embodiments of the subject invention utilize a cryptographic algorithm, where the effective key corresponds to the key defined by the specification of the cryptographic algorithm being used. Masked shares can be produced by performing the masking operation on the effective key and unpredictable data.

An example of Boolean masking using the XOR operator for two key shares is
keyshare1=effective_key XOR unpredictable_dat
keyshare2=unpredictable_data.

An example of Boolean masking using the XOR operator for three key shares is
keyshare1=effective_key XOR unpredictable_data1 XOR unpredictable_data2
keyshare2=unpredictable_data1
keyshare3=unpredictable_data2

An example of arithmetic(additive) masking using the +/− operators for two key shares is
keyshare1=effective_key—unpredictable_dat
keyshare2=unpredictable_data.

An example of arithmetic (additive) masking using the +/− operators for three key shares is
keyshare1=effective_key—unpredictable_data1—unpredictable_data2
keyshare2=unpredictable_data1
keyshare3=unpredictable_data2

An example of multiplicative masking using the * operators for three key shares is
keyshare1=effective_key * unpredictable_data1⁻¹* unpredictable_data2⁻¹
keyshare2=unpredictable_data1
keyshare3=unpredictable_data2

Key shares of a masked key can be unmasked to produce the effective key by using an unmasking operation.

An example of Boolean unmasking using the XOR operator for two key shares is effective_key=keyshare1 XOR keyshare2

An example of Boolean masking using the XOR operator for three key shares is effective_key=keyshare1 XOR keyshare2 XOR keyshare3

An example of arithmetic (additive) masking using the +/− operators for two key shares is effective_key=keyshare1+keyshare2

An example of arithmetic (additive) masking using the +/− operators for three key shares is effective_key=keyshare1+keyshare2 +keyshare3

An example of multiplicative masking using the * operators for three key shares is effective_key=keyshare1 * keyshare2 * keyshare3

Masking and unmasking operations are not limited to the previous examples as embodiments of the invention can utilize any logical function that has two or more inputs and an inverse can be used as a basis for masking and unmasking operations. Also, rather than receiving an effective key and masking the effective key, embodiments can generate the key share values directly so as to prevent the effective key value from ever being stored or transmitted.

### Example 1

In a specific embodiment, a pre-masked key is used and the key update function is performed on each masked share, or key share, which eliminates the need to perform unmasking and, therefore, eliminates any leaks associated with unmasking. In a specific embodiment, if a two mask XOR share is used, e.g., key shares keyₐ and key_{b}, and SHA256 is used as the key update function, then both key shares would be updated as keyₐ=SHA256(keyₐ) and key_{b}=SHA256(key_{b}), where the unmasked key, keyₐ XOR key_{b}, is never directly used or stored. This method eliminates the need to ever unmask the masked key. However, if the key update function is leaky, an attacker could obtain key information by analyzing the key update operation for each mask key share, or key share.

### Example 2

In a specific embodiment, when performing key updates on the individual masked key shares, or key shares, the update function can be unique for each mask share, or key share. For instance, as a derivation of Example 1, SHA256 and an LFSR could be used, where keyₐ=SHA256(keyₐ) and key_{b}=LFSR(key_{b}). This method can reduce the computational time required to perform the complete key update, and the different update functions can provide different additive properties to the key update function. In a specific embodiment, the hash update function makes the complete key update function non-invertible, and a key update function that is linear to the masking operation (such as an LFSR) provides improved leakage resistance to the complete key update function. In a further embodiment, the LFSR can be replaced with an affine transformation.

### Example 3

Since the key update functions can potentially leak key information, leakage reduction countermeasures should be used in the key update functions. In a specific embodiment, the key update functions utilize masked inputs and outputs. In a specific embodiment, two or more masked key shares are used as input and output of the key update function. The increase in masked shares and key storage memory provides more secure processing of the key update function. Additionally, key update functions that are linear to the masking operation process each share individually as a single masked operation, which helps minimize the overall key update leakage.

Referring to Example 2, utilizing the SHA hash and LFSR key update, this key update can be implemented using four masked shares as follows.
(keyₐ₁, keyₐ₂)=SHA256(keyₐ₁, keyₐ₂)
key_{b1}=LF SR(key_{b1})
key_{b2}=LFSR(key_{b2})
effective key=keyₐ₁ XOR keyₐ₂ XOR key_{b1} XOR key_{b2}

Referring to Example 2, utilizing the SHA hash and the affine transformation key update, this key update can be implemented using four masked shares as follows.
(keyₐ₁, keyₐ₂)=SHA256(keyₐ₁, keyₐ₂)
key_{b1}=Affine transformation (key_{b1})
key_{b2}=Affine transformation (key_{b2})
effective key=keyₐ₁ XOR keyₐ₂ XOR key_{b1} XOR key_{b2}

### Example 4

In a specific embodiment, when performing key updates on the individual masked key shares, or key shares, the update function can be unique for each mask share, or key share. For instance, the keyed cryptographic operation could be a symmetric key block cipher, like AES. For a resource constrained system it would be desirable to reuse the available AES module, whether implemented as as hardware or software, for the key update process. A leakage minimizing key update using with a three-share key store, an AES module that supports a two-share key, and additional data that is read from memory or received for each key update could be performed as follows.
(key₁, key₂)=AES256_encrypt(key₁=key₁, key₂=key₂, plaintext=additional data)key₃ stays unchanged effective_key=key₁ XOR key₂ XOR key₃

Aspects of the invention, such as receiving key shares or an effective key, storing key shares or an effective key, implementing cryptographic operations, combining key shares, and implementing key share update functions, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.7

Computer-readable media include both volatile and nonvolatile media, transient and non-transient media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology. CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification. It should be understood that the examples and embodiments described herein are for illustrative purposes only and that various modifications or changes in light thereof will be suggested to persons skilled in the art and are to be included within the spirit and purview of this application.

1-49. (canceled)

50. A method of updating key shares, comprising:
applying at least one key update function to a corresponding at least one key share of n key shares, such that each key update function of the at least one key update function is applied to the corresponding key share of the at least one key share of the n key shares, such that a corresponding at least one updated key share is produced,
wherein n is an integer greater than or equal to 2,
wherein when the n key shares are n-share unmasked, an effective key is produced,
wherein when:
(i) the at least one updated key share; and
(ii) key shares of the n key shares to which a key update function of the at least one key update function was not applied,
are n-share unmasked, an updated effective key is produced.

51. The method according to claim 50,
wherein each key share of the n key shares is independent of the effective key.

52. The method according to claim 50, further comprising:
receiving the n key shares.

53. The method according to claim 50, wherein applying at least one key update function to a corresponding at least one key share of n key shares is accomplished via a processor.

54. The method according to claim 50, wherein the n key shares are unmasked by applying an n-share unmasking operator to the n key shares.

55. The method according to claim 50,
wherein the n-share unmasking operator is additive and applying the n-share unmasking operator to the n key shares comprises adding the n key shares together,
wherein the n-share unmasking operator is multiplicative and applying the n-share unmasking operator to the n key shares comprises multiplying the n key shares together, or
wherein the n-share unmasking operator is XOR and applying the n-share unmasking operator to the n key shares comprises XORing the n key shares together.

56. The method according to claim 50, further comprising:
receiving the effective key; and
n-share masking the effective key to produce the n key shares.

57. The method according to claim 50, further comprising:
performing a keyed cryptographic operation, having an operation input and p operation key share inputs,
wherein:
(i) the n key shares, or
(ii) one or more key shares of the n key shares, and/or one or more combinations of key shares of the n key shares,
are the p operation key share inputs.

58. The method according to claim 50, further comprising:
applying the at least one key update function to the at least one updated key share, such that each key update function of the at least one key update function is applied to the corresponding updated key share of the at least one updated key share, such that a corresponding at least one updated key share is produced,
wherein when the at least one updated key share and key shares of the n key shares to which a key update function of the at least one key update function was not applied are n-share masked, an updated effective key is produced.

59. The method according to claim 50,
wherein:
(i) the at least one key update function comprises a block cipher, having a block cipher key, a block cipher input, and a block cipher output,
the block cipher is a symmetric key block cipher,
the key share of the at least one key share of the n key shares to which the block cipher is applied is the block cipher key,
the block cipher input is a constant data, and
the block cipher output is the updated key share of the at least one updated key share;
(ii) the at least one key update function comprises a block cipher, having a block cipher key, a block cipher input, and a block cipher output,
the block cipher is a symmetric key block cipher,
the key share of the at least one key share of the n key shares to which the block cipher is applied is the block cipher key,
the block cipher input is a received or stored input message, and
the block cipher output is the updated key share of the at least one updated key share;
(iii) the at least one key update function comprises a block cipher, having a block cipher key, a block cipher input, and a block cipher output,
the block cipher is a symmetric key block cipher,
a constant data is the block cipher key,
the block cipher input is the key share of the at least one key share of the n key shares to which the block cipher is applied, and
the block cipher output is the updated key share of the at least one updated key share; or
(iv) the at least one key update function comprises a block cipher, having a block cipher key, a block cipher input, and a block cipher output,
the block cipher is a symmetric key block cipher,
a received or stored input message is the block cipher key,
the block cipher input is the key share of the at least one key share of the n key shares to which the block cipher is applied, and
the block cipher output is the updated key share of the at least one updated key share.

60. The method according to claim 50,
wherein:
the at least one key update function comprises a m-input, m-output key update function, such that the m-input, m-output key update function comprises m inputs and m outputs,
wherein m is an integer greater than or equal to 2 and less than or equal to n,
wherein a first m key shares of the n key shares are the m inputs, and
wherein the m outputs are inputted to a second m key shares of the n key shares;
(ii) the at least one key update function comprises a first key update function;
the at least one key update function comprises a second key update function; and
the first key update function and the second key update function are the same key update function; or
(iii) the at least one key update function comprises a first key update function,
the at least one key update function comprises a second key update function, and
the first key update function and the second key update function are different key update functions.

61. The method according to claim 50, wherein n is 2, 3, or 4.

62. The method according to claim 50, wherein n is greater than 4.

63. The method according to claim 57,
wherein performing the keyed cryptographic operation comprises: applying a block cipher, having a block cipher key, a block cipher input, and a block cipher output.

64. The method according to claim 63,
wherein:
(i) the block cipher is used for encryption of plaintext into ciphertext,
the block cipher input is the plaintext,
the block cipher output is the ciphertext, and
the block cipher key is the n key shares; or
(ii) the block cipher is used for decryption of ciphertext into plaintext,
the block cipher input is the ciphertext,
the block cipher output is the plaintext, and
the block cipher key is the n key shares.

65. The method according to claims 57,
wherein performing a keyed cryptographic operation comprises: applying a keyed message authentication, having a keyed message authentication key, a keyed message authentication input, and a keyed message authentication output.

66. A circuit for updating key shares,
wherein the circuit is configured to apply at least one key update function to a corresponding at least one key share of n key shares, such that each key update function of the at least one key update function is applied to the corresponding key share of the at least one key share of the n key shares, such that a corresponding at least one updated key share is produced,
wherein n is an integer greater than or equal to 2,
wherein when the n key shares are n-share unmasked, an effective key is produced, and
wherein when:
(i) the at least one updated key share; and
(ii) key shares of the n key shares to which a key update function of the at least one key update function was not applied,
are n-share unmasked, an updated effective key is produced.

67. The circuit for updating key shares according to claim 66,
wherein the circuit is configured to implement a method of claim 50.

68. A method of performing keyed cryptographic operations, comprising:
performing the method of claim 57; and
performing keyed cryptographic operation having p operation key share inputs.

69. The method according to claim 57,
wherein p is less than n,
wherein the n key shares are unmasked by applying an n-share unmasking operation on the n key shares,
wherein a combination of two or more key shares of the n key shares is produced by performing a q-share unmasking operation on the two or more key shares of the n key shares, and
wherein:
q equals n-p; or
q is less than n-p.
